(19) United States
(12) Patent Application Publication
(10) Pub. No.: US 2022/0253575 A1
(43) Pub. Date: Aug. 11, 2022

(54) Node Grouping Method, Apparatus and Electronic Device

(71) Applicant: Beijing Baidu Netcom Science Technology Co., Ltd., Beijing (CN)

(72) Inventors: Kun FANG, Beijing (CN); Runyao DUAN, Beijing (CN)

(21) Appl. No.: 17/731,254

(22) Filed: Apr. 27, 2022

(30) Foreign Application Priority Data
May 8, 2021 (CN) 202110500446.0

(51) Int. Cl. G06F 30/20; G06F 17/16

(52) U.S. Cl. CPC G06F 30/20; G06F 2111/10; G06F 17/16

(57) ABSTRACT

This disclosure provides a node grouping method and apparatus and an electronic device, and relates to the field of evolutionary computing in quantum computing. The method includes: obtaining a graph of to-be-grouped nodes, wherein the graph of to-be-grouped nodes includes M first nodes; constructing a QAOA (quantum approximate optimization algorithm) node circuit graph based on the graph of to-be-grouped nodes, the node circuit graph including K nodes which including the M first nodes; generating a quantum entangled state of the node circuit graph that includes target quantum states of the K nodes in the node circuit graph; performing a group measurement on each of the K nodes sequentially based on the target quantum states of the K nodes to obtain a target group measurement result of the M first nodes; determining a grouping output result of the M first nodes based on the target group measurement result.

### CROSS-REFERENCE TO RELATED APPLICATION

The present application claims priority to the Chinese patent application No. 202110500446.0 filed in China on May 8, 2021, the disclosure of which is incorporated herein by reference in its entirety.

### TECHNICAL FIELD

The present disclosure relates to the field of quantum computing technology, in particular to the field of evolutionary computing in quantum computing, and specifically to a node grouping method and apparatus and an electronic device.

### BACKGROUND

The Max-Cut (maximum cut) problem is a basic problem in graph theory and combinatorial optimization. It is also a NP (Non-deterministic Polynomial)-hard problem. The Max-Cut problem refers to partitioning the graph's nodes into two complementary sets, so that the quantity of the edges connecting the nodes in the two different sets is maximized. It is widely used in many fields such as statistical physics, image processing, network design, very large-scale integrated circuit design and data clustering analysis.

Currently, the quantum approximate optimization algorithm (QAOA) can be used to approximately solve the Max-Cut problem, and the QAOA usually evolves in a quantum circuit model.

### SUMMARY

The present disclosure provides a node grouping method and apparatus and an electronic device.

According to a first aspect of the present disclosure, a node grouping method is provided, including:

obtaining a graph of nodes to be grouped, wherein the graph of nodes to be grouped includes M first nodes, and M is an integer greater than 1;

constructing a QAOA (quantum approximate optimization algorithm) node circuit graph based on the graph of nodes to be grouped, wherein the node circuit graph includes K nodes, the K nodes include the M first nodes, and K is an integer greater than or equal to M;

generating a quantum entangled state of the node circuit graph, wherein the quantum entangled state includes the target quantum states of the K nodes in the node circuit graph;

performing a group measurement on each of the K nodes sequentially based on the target quantum states of the K nodes in the node circuit graph to obtain a target group measurement result of the M first nodes; and

determining a grouping output result of the M first nodes based on the target group measurement result of the M first nodes.

According to a second aspect of the present disclosure, a node grouping apparatus is provided, including:

an obtaining module, configured to obtain a graph of nodes to be grouped, wherein the graph of nodes to be grouped includes M first nodes, and M is an integer greater than 1;

a construction module, configured to construct a QAOA (quantum approximate optimization algorithm) node circuit graph based on the graph of nodes to be grouped, wherein the node circuit graph includes K nodes, the K nodes include the M first nodes, and K is an integer greater than or equal to M;

a generation module, configured to generate a quantum entangled state of the node circuit graph, wherein the quantum entangled state includes the target quantum states of the K nodes in the node circuit graph;

a group measurement module, configured to perform a group measurement on each of the K nodes sequentially based on the target quantum states of the K nodes in the node circuit graph to obtain a target group measurement result of the M first nodes; and

a determination module, configured to determine the grouping output result of the M first nodes based on the target group measurement result of the M first nodes.

According to a third aspect of the present disclosure, an electronic device is provided, including:

at least one processor; and

a storage communicatively connected to the at least one processor,

wherein the storage stores therein an instruction configured to be executed by the at least one processor, and the at least one processor is configured to execute the instruction, to implement any method provided in the first aspect of the present disclosure.

According to a fourth aspect of the present disclosure, a non-transitory computer readable storage medium storing therein a computer instruction is provided, wherein the computer instruction is configured to be executed by a computer, to implement any method provided in the first aspect of the present disclosure.

According to a fifth aspect of the present disclosure, a computer program product including a computer program is provided, wherein the computer program is configured to be executed by a processor, to implement any method provided in the first aspect of the present disclosure.

It is understood, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The drawings are used for facilitating a better understanding of the solution, and do not constitute a limitation on the present disclosure.

FIG. 1 is a schematic flowchart of a node grouping method according to a first embodiment of the present disclosure;

FIG. 2 is a schematic structural diagram of a graph of nodes to be grouped according to an example in an embodiment of the present disclosure;

FIG. 3 is a schematic structural diagram of a first node graph;

FIG. 4 is a schematic structural diagram of a second node graph;

FIG. 5 is a schematic structural diagram of a QAOA node circuit graph;

FIG. 6 is a schematic structural diagram of a node grouping apparatus according to a second embodiment of the present disclosure; and

FIG. 7 is a schematic block diagram of an exemplary electronic device 700 in which embodiments of the present disclosure may be implemented.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications may be made in the described embodiments without departing from the scope and spirit of the present disclosure. Further, for clarity and conciseness, descriptions of known functions and structures are omitted.

The first embodiment.

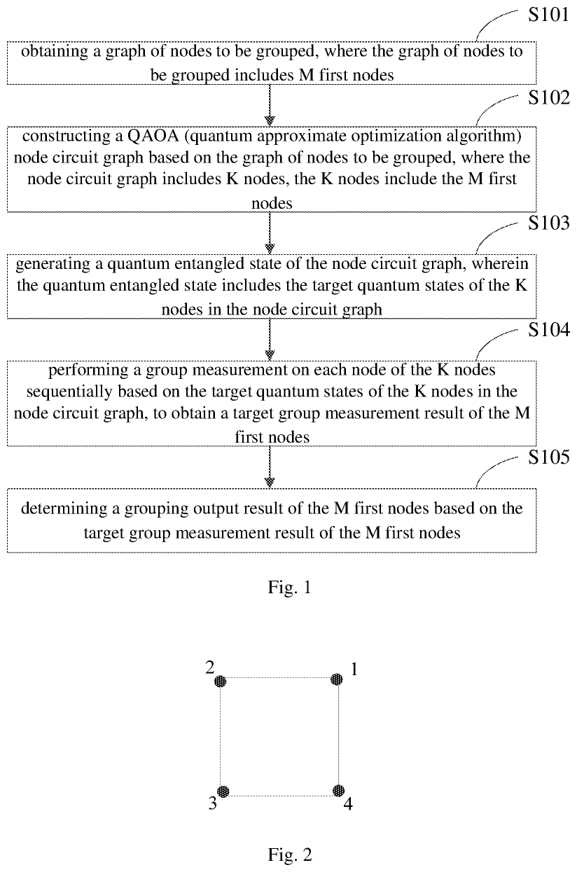

As shown in FIG. 1, the present disclosure provides a node grouping method, which includes the following steps S101 to S105.

Step S101: obtaining a graph of nodes to be grouped, where the graph of nodes to be grouped includes M first nodes, wherein M is an integer greater than 1.

In this embodiment, the node grouping method relates to the field of quantum computing technology, especially to the field of evolutionary computing in quantum computing. The method can be widely applied in many fields such as statistical physics, image processing, network design, very large-scale integrated circuit design, and data clustering analysis.

In practical use, the node grouping method in embodiments of the present disclosure can be implemented by the node grouping apparatus in embodiments of the present disclosure. The node grouping apparatus in embodiments of the present disclosure can be provided in any electronic device to implement the node grouping method in embodiments of the present disclosure. The electronic device may be a server or a terminal, which is not specifically limited herein.

The graph of nodes to be grouped refers to an undirected graph, which is formed by at least one node and undirected edge. FIG. 2 is a schematic structural diagram of a graph of nodes to be grouped according to an example in an embodiment of the present disclosure. As shown in FIG. 2, the graph of nodes to be grouped includes a node 1, a node 2, a node 3, and a node 4, and includes undirected edges formed by these four nodes. The undirected edges formed by these four nodes refer to the undirected edges connecting two adjacent nodes among these four nodes.

The M first nodes in the graph of nodes to be grouped can be grouped according to the Max-Cut problem. The Max-Cut problem is described specifically as follows: given a graph of nodes to be grouped, which is denoted by G=(V, E), i.e., graph G, where V is the set of nodes and E is the set of undirected edges, the nodes in the set of nodes need to be partitioned into two groups complementing each other, which are denoted by V₀ and V₁ respectively, such that a quantity of edges connecting the nodes in the two groups in the graph of nodes to be grouped is maximized.

Mathematically, the group measurement result of a node set can be represented by an M-bit string z=z₁ . . . z_{M}, where M is the quantity of nodes in the graph of nodes to be grouped, zᵢ=0 denotes that the node i belongs to the group V₀, zᵢ=1 denotes that the node i belongs to the group V₁, so that the grouping manner corresponding to the node set can be obtained, then the Max-Cut problem amounts to solving a combinatorial optimization problem such as the following formula (1):

$${max}_{z ∈ {\{ 0 , 1 \}}^{M}} c ( z ) , c ( z ) = {\sum }_{( u , v ) ∈ E} ( {Z}_{u} ⊕ {Z}_{v} ) \qquad ( 1 )$$

In the above formula (1), ⊕ denotes an exclusive-OR (XOR) operation of two input values.

As shown in FIG. 2, when the nodes are grouped, node 1 and node 2 may be grouped into one group, and node 3 and node 4 can be grouped into another group. The edges connecting these two groups of nodes include the undirected edge connecting node 2 and node 3, and the undirected edge connecting node 1 and node 4, and the quantity of the edges is 2. If node 1 and node 3 are grouped into one group and node 2 and node 4 are grouped into another group, the edges connecting these two groups of nodes include the undirected edge connecting node 1 and node 2, the undirected edge connecting node 1 and node 4, the undirected edge connecting node 2 and node 3, and the undirected edge connecting node 3 and node 4, and the quantity of the edges is 4. The purpose of solving the Max-Cut problem is to group these four nodes by using an evolutionary algorithm such that the quantity of edges connecting the two groups of nodes in the graph of nodes to be grouped is maximized In the case of the foregoing graph of nodes to be grouped, the Max-Cut problem is solved by grouping node 1 and node 3 into one group and grouping node 2 and node 4 into another group.

The graph of nodes to be grouped may be obtained in many ways, for example, by receiving graph construction parameters input by the user and automatically constructing the graph of nodes to be grouped, wherein the construction parameters may include the quantity of nodes, the quantity of edges, and the construction manner. It is also possible to obtain the node graph pre-stored by the node grouping apparatus and use it as the graph of nodes to be grouped, or to receive the graph of nodes to be grouped sent by other electronic devices.

Step S102: constructing a QAOA (quantum approximate optimization algorithm) node circuit graph based on the graph of nodes to be grouped, where the node circuit graph includes K nodes, the K nodes include the M first nodes, wherein K is an integer greater than or equal to M.

In this embodiment, the Max-Cut problem can be solved using the QAOA algorithm. The QAOA algorithm is a quantum algorithm proposed by Edward Farhi et al. through the idea of mixed iteration of classical computing and quantum computing, and can run on a quantum computing device.

When performing the evolution of QAOA algorithm, it is necessary to first construct the QAOA node circuit graph, wherein the node circuit graph refers to a spatial graph formed by K nodes and undirected edges connecting these K nodes. The QAOA node circuit graph may include multiple layers. Each layer may be constructed based on the graph of nodes to be grouped, and each layer may include M first nodes in the graph of nodes to be grouped, that is, the K nodes include the M first nodes.

To put it simply, if the node circuit graph is regarded as a general system, then the node circuit graph can include multiple subsystems, that is, each layer within the node circuit graph may be regarded as a subsystem, and each subsystem may be generated based on the graph of nodes to be grouped.

The QAOA node circuit graph can be constructed based on the graph of nodes to be grouped. In an optional implementation, the construction manner may be as follows:

adding a second node to each undirected edge in the graph of nodes to be grouped, to obtain first node graphs;

removing each undirected edge in the graph of nodes to be grouped, to obtain second node graphs; and

alternately stacking the first node graphs and the second node graphs in parallel and sequentially to form the QAOA node circuit graph, wherein the quantity of the first node graphs is greater than the quantity of the second node graphs;

wherein the K nodes further comprise added second nodes.

In addition, other manners of construction may be used. The principle is that the QAOA node circuit graph constructed in different manners has the same structure, and the manner of construction of the node circuit graph is not limited herein.

Step S103: generating a quantum entangled state of the node circuit graph, wherein the quantum entangled state includes the target quantum states of the K nodes in the node circuit graph.

The quantum entangled state in this step refers to a physical state that describes the overall system of node circuit graph, which may be a vector, such as a column vector including the target quantum states of the K nodes in the node circuit graph, and each node may have a target quantum state in the node circuit graph, and the target quantum state of each node in the node circuit graph may be denoted by a quantum state of one quantum bit. In quantum physics, a quantum state refers to a state that describes an isolated system and contains all the information of the system, that is, the quantum entangled state includes the quantum states of all nodes of the node circuit graph in the overall system of the node circuit graph.

There may be multiple manners to generate the quantum entangled state of the node circuit graph. In an optional implementation, the generating the quantum entangled state of the node circuit graph includes:

generating the quantum state of each node of the K nodes;

performing a tensor product operation based on the quantum state of each node of the K nodes to obtain a first operation result;

performing tensor product and matrix multiplication operations on Q pieces of control information to obtain a second operation result, wherein Q is determined based on the quantity of undirected edges included in the node circuit graph, and the control information is information corresponding to the control Z-gate;

perform multiplication of the first operation result and the second operation result to obtain the quantum entangled state of the node circuit graph.

In this implementation, the quantum entangled state of the node circuit graph can be constructed in the node grouping apparatus based on the structure of the node circuit graph, so that the evolution of the QAOA algorithm can be implemented locally.

In another optional implementation, the generating the quantum entangled state of the node circuit graph includes:

obtaining a cluster state corresponding to the node circuit graph;

clipping the cluster state based on the node circuit graph, to obtain the quantum entangled state of the node circuit graph.

In this implementation, the node grouping apparatus may request, based on the constructed QAOA node circuit graph, a cluster state of a suitable size from another electronic device such as a cloud-based quantum server to obtain a cluster state corresponding to the node circuit graph. The cluster state refers to a generic quantum entangled state of the system. Afterwards, the cluster state is clipped according to the structure of the constructed QAOA node circuit graph, to obtain the quantum entangled state of the node circuit graph.

Since the requested cluster state is a generic quantum state that is independent of the QAOA algorithm, the another electronic device such as a cloud-based quantum server cannot know what data is used and what algorithm is executed, thereby protecting the privacy and computational security of the user during the evolution of the QAOA algorithm.

Step S104: performing a group measurement on each node of the K nodes sequentially based on the target quantum states of the K nodes in the node circuit graph, to obtain a target group measurement result of the M first nodes.

The QAOA algorithm usually evolves under the framework of the quantum circuit model, to solve the Max-Cut problem corresponding to the graph of nodes to be grouped. However, because the quantum circuit model has a very short quantum bit coherence time in physical experiments, the quantum algorithm designed based on the quantum circuit model will be limited by the coherence time, resulting in the quantity of layers of the quantum circuit cannot be too large.

In this way, the evolution of the QAOA algorithm will be limited by the coherence time due to the need to perform quantum gate operations on the quantum states in sequence, thus it is impossible in the physical implementation to use deep layers of quantum circuit to achieve the required algorithm evolution effect, resulting in relatively poor evolutionary effect of the QAOA algorithm.

In this step, for the quantum entangled state of the prepared QAOA node circuit graph, group measurement may be performed on each of the K nodes sequentially by using a single-quantum-bit measurement manner, to obtain the target group measurement result of the M first nodes.

Specifically, based on the target quantum states of the K nodes in the node circuit graph, group measurement may be performed on each of the K nodes sequentially to obtain the group measurement results of the K nodes; subsequently, the target group measurement result of the M first nodes may be determined based on the group measurement results of the K nodes.

For example, if the node circuit graph includes 30 nodes, then the quantum entangled state includes a quantum state of 30 quantum bits. The group measurement can be performed on the node corresponding to the quantum state of each quantum bit sequentially to obtain the group measurement result of the node, and finally the group measurement results of the 30 nodes can be obtained.

Since in the group measurement process, the group measurement results have a dependency relationship, that is, the group measurement results of the node whose group measurement is performed later may depend on the group measurement results of the node whose group measurement is performed earlier, it is necessary in the group measurement to sequentially perform group measurements on the nodes in the node circuit graph according to a preset sequence. For the preset sequence, the subsequent implementations will further elaborate on this.

In addition, since the target group measurement result of the first node depends on the group measurement result of the node whose group measurement is performed last among the K nodes, it is necessary to determine the group measurement results of the K nodes before determining the target group measurement result of the M first nodes based on the group measurement results of the K nodes. The specific process of determining the target group measurement result of the M first nodes based on the group measurement results of the K nodes will be described in detail in the subsequent implementations.

The target group measurement result of each first node in the M first nodes may fall into two cases, each case may represent the group to which the node belongs, and the first case may be represented by a value of 0, indicating that the node belongs to the group V₀, the second case may be represented by 1, which means that the node belongs to the group V₁.

Step S105: determining a grouping output result of the M first nodes based on the target group measurement result of the M first nodes.

One target group measurement result of the M first nodes may be a bit string, denoted by o, and the quantity of bits of the bit string is M. For example, when M is 4, o can be represented as a 4-bit string formed by “0” and “1”. The grouping output result of the M first nodes may be determined based on the string.

For example, as shown in FIG. 2, the target group measurement result of the M first nodes, that is o, is “0101”, which represents, from left to right, the grouping status of node 1, node 2, node 3, and node 4, respectively, so that the grouping output result may be that node 1 and node 3 are grouped into one group, and node 2 and node 4 are grouped into another group, which can be represented as V₀={1,3} and V₁{2,4}.

The grouping output result of the M first nodes may be determined based on one target group measurement result of the M first nodes, or may be determined based on multiple target group measurement results of the M first nodes, which is not specifically limited herein.

In practical applications, due to the randomness of group measurements, this step can be performed N times to obtain N target group measurement results of the M first nodes. N is a positive integer, and usually greater than 1. The grouping output result of the M first nodes are determined based on the N target group measurement results. Specifically, the grouping manner corresponding to the most frequently occurred target group measurement result among the N target group measurement results may be determined as the grouping output result of the M first nodes.

For example, among N target group measurement results, the bit string “0101” occurs most frequently. The grouping manner corresponding to the target group measurement result is that node 1 and node 3 are grouped into one group, and node 2 and node 4 are grouped into another group, then the grouping output result of the M first nodes may be V₀={1,3} and V₁={2,4}.

In addition, the measurement manner in the group measurement process is determined based on angle information. The measurement manner will be different when the angle information is different, and the final grouping effect will be different. Therefore, this step can be performed N times to determine the grouping score of the measurement manner corresponding to the angle information, and the angle information is updated based on the grouping score, and the grouping test is repeated based on the updated angle information, so as to finally achieve the purpose of improving the grouping effect.

The method in this embodiment includes: obtaining a graph of nodes to be grouped, wherein the graph of nodes to be grouped includes M first nodes; constructing a QAOA (quantum approximate optimization algorithm) node circuit graph based on the graph of nodes to be grouped, wherein the node circuit graph includes K nodes and the K nodes include the M first nodes; generating a quantum entangled state of the node circuit graph, wherein the quantum entangled state includes the target quantum states of the K nodes in the node circuit graph; performing a group measurement on each of the K nodes sequentially based on the target quantum states of the K nodes in the node circuit graph to obtain a target group measurement result of the M first nodes; determining a grouping output result of the M first nodes based on the target group measurement result of the M first nodes. In this way, a single quantum bit can be measured based on the quantum entangled state of QAOA, to perform group measurements on each node sequentially, so that quantum gate operations performed on quantum states in sequence can be avoided when performing algorithm evolution, which can reduce the constraints on the coherence time and improve the evolutionary effect of the QAOA algorithm, which in turn can improve the effect of node grouping.

Moreover, this evolution manner of the QAOA algorithm for solving the Max-Cut problem in this embodiment is easier to implement on hardware platforms such as ion traps and quantum optics.

Optionally, the graph of nodes to be grouped includes undirected edges formed by the M first nodes, and step S102 specifically includes:

adding a second node to each undirected edge of the graph of nodes to be grouped, to obtain first node graphs;

removing each undirected edge of the graph of nodes to be grouped, to obtain second node graphs;

alternately stacking the first node graphs and the second node graphs in parallel and sequentially to form the QAOA node circuit graph, wherein the quantity of the first node graphs is greater than the quantity of the second node graphs;

wherein the K nodes further include added second nodes, and the node circuit graph further includes undirected edges formed by the K nodes.

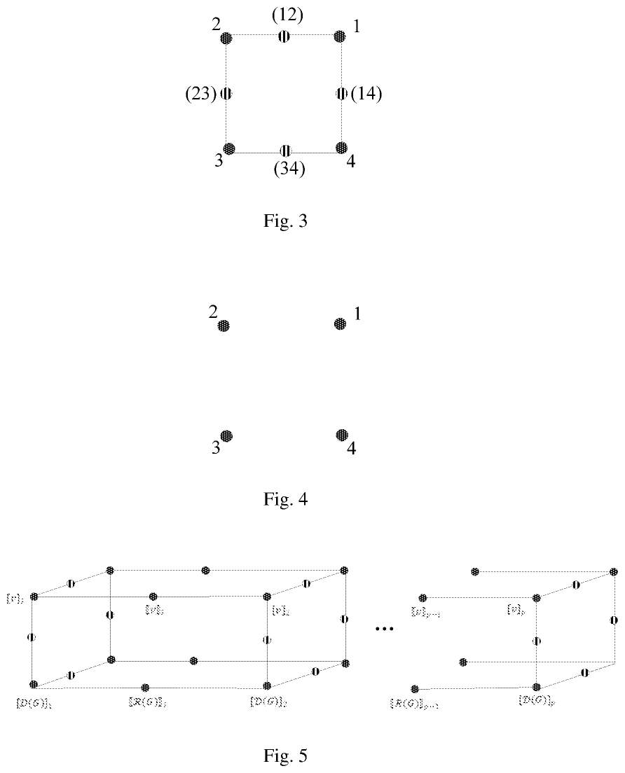

In this implementation, refer to FIG. 3, which is a schematic structural diagram of the first node graph and is the first node graph generated based on FIG. 2. As shown in FIG. 3, a second node may be added at a central point of each undirected edge of the graph of nodes to be grouped, to obtain a first node graph. The first node graph can be called a decorated graph of the graph of nodes to be grouped.

Let the set of all newly added nodes be D={(uv): (u, v) ∈ E}, and let the set of nodes in the decorated graph be [symbol] (V)=V ∪ D. Each newly added second node divides the original undirected edge into two new undirected edges, and let the set of all new undirected edges be [symbol] (E)={(u, (uv)), ((uv), v): (u, v) ∈ E}, then the decorated graph of the graph G is denoted as [symbol] (G)=( [symbol] (V), [symbol] (E)).

FIG. 4 is a schematic structural diagram of the second node graph. The second node graph in FIG. 4 is generated based on FIG. 2. As shown in FIG. 4, all undirected edges of the graph of nodes to be grouped can be removed to obtain the second node graph, and this second node graph can be called the edge-removed graph of the graph of nodes to be grouped, denoted as [symbol] (G)=(V, Ø), Ø means the edge-removed graph has no undirected edges and is an empty set.

The QAOA node circuit graph may be constructed based on the first node graph and the second node graph, which may be called a QAOA graph. The decorated graphs [symbol] (G) and the edge-removed graphs [symbol] (G) are alternately stacked in parallel to form a new graph, which is the QAOA graph.

In order to distinguish the elements on each layer conveniently, square brackets and subscript, i.e., [ [symbol] (G)]ᵢ, may be used for denoting the i-th copy of graph [symbol] (G), and double square brackets and subscript, i.e., [symbol] [symbol] (G) [symbol] ᵢ, may be used for denoting the i-th copy of the graph [symbol] (G). Similarly, [V]ᵢ,[D]ᵢ and [symbol] V [symbol] ᵢ may be used for denoting the sets of nodes on the corresponding layer respectively.

According to the above definition, FIG. 5 is a schematic structural diagram of the QAOA node circuit graph. As shown in FIG. 5, given a graph G and a positive integer p, the corresponding QAOA graph is constructed as follows: first, according to the sequence of [ [symbol] (G)]₁, [symbol] [symbol] (G) [symbol] ₁, [ [symbol] (G)]₂, . . . , [symbol] [symbol] (G) [symbol] ₚ₋₁, [ [symbol] (G)]ₚ, arrange the layers in parallel, then add new undirected edges between corresponding nodes of adjacent layers, where the new undirected edges are denoted by ([v]ᵢ, [symbol] v [symbol] ᵢ) and ( [symbol] v [symbol] ⱼ, [v]ⱼ₊₁) , v ∈ V, i, j ∈ {1, . . . , p−1}, and finally generate a QAOA graph, denoted as QAOA(G, p), where p is equal to the quantity of copies of the first node graph. The final QAOA graph includes 2p−1 layers.

In this implementation, a first node graph is obtained by adding a second node to each undirected edge of the graph of nodes to be grouped; a second node graph is obtained by removing each undirected edge of the graph of nodes to be grouped; and the first node graphs and the second node graphs are alternately stacked parallelly and sequentially to form a QAOA node circuit graph, and the quantity of the first node graphs is greater than the quantity of the second node graphs. In this way, the QAOA graph can be constructed very simply, to lay the foundation for subsequent group measurements.

Optionally, the step S104 specifically includes:

performing, sequentially according to the stacking order of the node graphs in the node circuit graph, the group measurement on each node in the node graphs based on the target quantum states of the K nodes in the node circuit graph, to obtain group measurement results of the k nodes; and

determining a target group measurement result of the M first nodes based on the group measurement results of the K nodes.

In this implementation, when performing group measurements, it is necessary to sequentially perform group measurements on the nodes in the node circuit graph in a preset order, where the preset order may include the stacking order of the node graphs in the node circuit graph, so as to perform group measurement on each node in the node graphs sequentially according to the stacking order of the node graphs in the node circuit graph.

Specifically, the group measurement may be performed on each node in a 1^{st} first node graph initially, and after the measurement is completed, the group measurement may be performed on each node in a 1^{st} second node graph stacked after the 1^{st} first node graph, subsequently the group measurement is performed on each node in a 2^{nd} first node graph, and so on, and finally the group measurement is performed on each node in the last first node graph, that is, the p-th first node graph, to obtain the group measurement results of the K nodes.

In the group measurement process, the group measurement results of the nodes in the node graph measured later may depend on the group measurement results of the nodes in the node graph measured previously. The dependency relationship will be elaborated in the following implementations.

In this way, the group measurement is performed on each node in the node graphs sequentially according to the stacking order of the node graphs in the node circuit graph, so that group measurement of each node in the node circuit graph can be achieved and group measurement results of the K nodes can be obtained.

Optionally, the performing, sequentially according to the stacking order of the node graphs in the node circuit graph, the group measurement on each node in the node graphs based on the target quantum states of the K nodes in the node circuit graph to obtain group measurement results of the k nodes includes:

performing the group measurement on each second node of the first node graph based on the target quantum state of the second node in the node circuit graph by using a first target measurement manner, to obtain group measurement results of second nodes in the first node graph, wherein the first target measurement manner is a first measurement manner in which the measurement angle is determined based on group measurement results of first nodes in a first target node graph and first angle information, and the first target node graph is a second node graph stacked before the first node graph;

performing, in a case that a second node graph is stacked after the first node graph, the group measurement on each first node of the first node graph based on the target quantum state of the first node in the node circuit graph by using a second target measurement manner, to obtain group measurement results of M first nodes in the first node graph, wherein the second target measurement manner is a second measurement manner in which the measurement angle is 0;

performing the group measurement on each first node of the second node graph based on the target quantum state of the first node in the node circuit graph by using a third target measurement manner, to obtain group measurement results of M first nodes in the second node graph, wherein the third target measurement manner is a second measurement manner in which the measurement angle is determined based on the group measurement results of nodes in a second target node graph and second angle information, and the second target node graph is a first node graph stacked before the second node graph; and

performing, in a case that there is no second node graph stacked after the first node graph, the group measurement on each first node of the first node graph based on the target quantum state of the first node in the node circuit graph by using a fourth target measurement manner, to obtain group measurement results of M first nodes in the first node graph, wherein the fourth target measurement manner is a first measurement manner in which the measurement angle is determined based on the group measurement results of second nodes in the first node graph and second angle information.

In this implementation, after generating the quantum entangled state of the QAOA graph, a single-bit measurement scheme can be used for performing group measurement on each node in the node circuit graph based on the quantum entangled state. The single-bit measurement scheme is described in detail below.

In the single-bit measurement scheme, there are mainly two measurement manners, namely the first measurement manner and the second measurement manner. Each measurement manner is given by a pair of orthogonal vectors with parameters, where the parameter may be a measurement angle parameter.

The first measurement manner may be represented as: [symbol] ^{x}(θ)={R^{x}(θ)|0 [symbol] , R^{x}(θ)|1 [symbol] }, the second measurement manner may be represented as [symbol] ^{z}(θ)={R^{z}(θ)|+), R^{z}(θ)|− [symbol] }, where θ is the measurement angle parameter,

$$\vert 0 〉 = [ \begin{matrix}1 \\ 0\end{matrix} ] and \vert 1 〉 = [ \begin{matrix}0 \\ 1\end{matrix} ]$$

is the calculation base, |+ [symbol] =(|0 [symbol] +|1 [symbol] )/\sqrt{2}, |− [symbol] =(|0 [symbol] −|1 [symbol] )/\sqrt{2}, and R^{x}(θ)=e^{-iθX/2} is a single-bit rotation gate around the x-axis, and R^{z}(θ)=e^{-iθZ/2} is a single-bit rotation gate around the z axis, X=

$$[ \begin{matrix}0 & 1 \\ 1 & 0\end{matrix} ] , Z = [ \begin{matrix}1 & 0 \\ 0 & - 1\end{matrix} ] .$$

In addition, when the measurement angle in the second measurement manner is 0, the measurement manner is defined a χ:= [symbol] ^{z}(0)={|+ [symbol] , |− [symbol] }.

Specifically, the input angle information includes first angle information and second angle information. The first angle information is a vector γ=(γ₁, . . . , γₚ) and the second angle information is a vector β=(β₁, . . . , βₚ).

First, based on the target quantum state of each second node [(uv)]ᵢ on the layer [ [symbol] (G)]ᵢ, that is, the first node graph, group measurement of the quantum bit on each second node is performed by using a first target measurement manner, and the first target measurement manner is a first measurement manner in which the measurement angle is determined based on the group measurement results of the first nodes in the second node graph stacked before the first node graph and the first angle information, and the measurement angle is represented in the following formula (2).

$$γ ( {[ ( u v ) ]}_{i} ) = {( - 1 )}^{( {Σ}_{k = 1}^{i - 1} s ( {〚 v 〛}_{k} ) + {Σ}_{k = 1}^{i - 1} s ( {〚 u 〛}_{k} ) )} {γ}_{i} \qquad ( 2 )$$

The group measurement result of each second node [(uv)]ᵢ on the layer [ [symbol] (G)]ᵢ is recorded as s([(uv)]ᵢ).

When i is equal to 1, that is, when the first node graph is the initial node graph in the node circuit graph and the node circuit graph includes multiple node graphs, it may be defined the summation Σₖ₌₁⁰(⋅)≡0, s( [symbol] v [symbol] ₖ) denotes the group measurement result of the first node represented by the index v in the second node graph stacked before the first node graph, and s( [symbol] u [symbol] ₖ) denotes the group measurement result of the first node represented by the index u in the second node graph stacked before the first node graph.

Based on the target quantum state of each first node [v]ᵢ on the first node graph, that is, the layer [ [symbol] (G)]ᵢ, group measurement of the quantum bit on each first node is performed by using the second target measurement manner, and the second target measurement manner is the second measurement manner in which the measurement angle is 0, that is, the measurement manner χ. The group measurement result of each first node [v]ᵢ on the layer [ [symbol] (G)]ᵢ is recorded as s([v]ᵢ).

Based on the target quantum state of each first node [symbol] v [symbol] ᵢ on the second node graph, that is, the layer [symbol] [symbol] (G) [symbol] ᵢ, group measurement of the quantum bit on each first node is performed by using the third target measurement manner, and the third target measurement manner is the second measurement manner in which the measurement angle is determined based on the group measurement results of the nodes in the first node graph stacked before the second node graph and the second angle information, and the measurement angle is represented in the following formula (3).

$$β ( {〚 v 〛}_{i} ) = {( - 1 )}^{( 1 + {Σ}_{k = 1}^{i} s ( {[ D ]}_{k} , v ) + {Σ}_{k = 1}^{i} s ( {[ v ]}_{k} ) )} {β}_{i} \qquad ( 3 )$$

The group measurement result of each first node [symbol] v [symbol] ᵢ on the graph layer [symbol] [symbol] (G) [symbol] ᵢ is recorded as s([v]ᵢ).

s([D]ₖ, v)=Σ_{u∈N}_{_{G}}₍ᵥ₎s([(uv)]ₖ), N_{G}(v) is the neighborhood of node v in graph G, that is, the set of all nodes adjacent to node v.

The value of i can be any positive integer ranging from 1 to p−1, and p is a positive integer, usually an integer greater than 1.

Based on the above group measurement process, the group measurement results of nodes in all layers before the p-th first node graph, that is, the last layer, can be obtained.

It should be noted that the group measurements are performed on the first nodes and the second nodes in the layer [ [symbol] (G)]ᵢ, that is, the first node graph, separately, and since there is no dependency on the measurement angle, the experiment has no requirement on the precedence relationship between the group measurements and the group measurements can be performed simultaneously to reduce the algorithm running time.

In addition, for the p -th first node graph, group measurement of the quantum bit on each second node may be performed based on the target quantum state of each second node [(uv)]ₚ on the layer [ [symbol] (G)]ₚ by using the first target measurement manner, and the first target measurement manner is the first measurement manner in which the measurement angle is determined based on the group measurement result of the first node in the second node graph stacked before the first node graph and the first angle information, and the measurement angle is represented by the following formula (4).

$$γ ( {[ ( u v ) ]}_{p} ) = {( - 1 )}^{( {Σ}_{k = 1}^{p - 1} s ( {〚 v 〛}_{k} ) + {Σ}_{k = 1}^{p - 1} s ( {〚 u 〛}_{k} ) )} {γ}_{p} \qquad ( 4 )$$

The group measurement result of each second node [(uv)]ₚ on the layer [ [symbol] (G)]ₚ is recorded as s([(uv)]ₚ).

Based on the target quantum state of each first node [v]ₚ on the layer [ [symbol] (G)]ₚ, group measurement of the quantum bit on each first node may be performed by using a fourth target measurement manner, and the fourth target measurement manner is the first measurement manner in which the measurement angle is determined based on the group measurement result of the second node in the p-th first node graph and the second angle information. Further, when the node circuit graph includes a plurality of first node graphs, the fourth target measurement manner is specifically the first measurement manner in which the measurement angle is determined based on the group measurement result of the second node in the p-th first node graph, the group measurement results of the nodes in the first node graph stacked before the p-th first node graph, and the second angle information, and the measurement angle is represented by the following formula (5).

$$β ( {[ v ]}_{p} ) = {( - 1 )}^{( 1 + {Σ}_{k = 1}^{ρ} s ( {[ D ]}_{k} , v ) + {Σ}_{k = 1}^{ρ - 1} s ( {[ v ]}_{k} ) )} {β}_{p} \qquad ( 5 )$$

The group measurement result of each first node [v]ₚ on the layer [ [symbol] (G)]ₚ is recorded as s([v]ₚ).

In this way, the group measurement results of the K nodes can be obtained, and the target group measurement result of the M first nodes is determined based on the obtained group measurement results of the K nodes, so that the grouping of the M first nodes can be realized by using a single-bit measurement scheme, which in turn enables a user equipped with merely a single-bit measurement apparatus to perform node grouping, thereby greatly simplifying the measurement apparatus.

Optionally, the determining the target group measurement result of the M first nodes based on the group measurement results of the K nodes includes calculating, for each first node of the M first nodes, a summation of the group measurement result of the first node in the p-th first node graph and the group measurement result of the first node in the third target node graph to obtain the target value corresponding to the first node, wherein the third target node graph is a second node graph stacked before the p-th first node graph, and p is equal to the quantity of the first node graphs; performing a modulo operation on the target value to obtain target group measurement result of the first node.

In this implementation, for each first node of the M first nodes, the following formula (6) can be used for determining its target group measurement result.

$$o ( v ) = s ( {[ v ]}_{p} ) + {\sum }_{k = 1}^{p - 1} s ( {〚 v 〛}_{k} ) mod 2 ∀ v ∈ V \qquad ( 6 )$$

wherein o(v) denotes the target group measurement result of the first node v among the M first nodes, s([v]ₚ) denotes the group measurement result of the first node v in the p-th first node graph, that is, the last first node graph, and s( [symbol] v [symbol] ₖ) denotes the group measurement result of the first node v in the second node graph before the p-th first node graph; the group measurement results of the first nodes v in all second node graphs is summed up and added to the group measurement result of the first node v in the last first node graph to obtain the target value corresponding to the first node v, then modulo 2 operation is performed on the target value to finally obtain the target group measurement result of the first node v.

The target group measurement result of each first node is determined in a similar way, and finally the target group measurement result o of the M first nodes is obtained, wherein o=(o(1), . . . , o(M)). In this way, group measurements can be performed on each of the K nodes to determine the target group measurement result of the M first nodes.

Optionally, the step S104 specifically includes:

performing the target grouping operation N times to obtain N target group measurement results of the M first nodes, wherein N is a positive integer, and the target grouping operation is: performing the group measurement on each of the K nodes sequentially based on the target quantum states of the K nodes in the node circuit graph;

determining a first target function value based on the N target group measurement results, wherein the first target function value is used for denoting the grouping score of the M first nodes in the performing the target grouping operation N times;

updating angle information in the target grouping operation based on the first target function value, wherein the angle information is used for determining a measurement angle for performing the group measurement on each of the K nodes in the target grouping operation;

performing, based on the updated angle information, the target grouping operation N times again to determine a second target function value; and

determining, in a case that the difference between the first target function value and the second target function is less than a preset threshold, a grouping manner corresponding to a most frequently occurred target group measurement result among the N target group measurement results as a grouping output result of the M first nodes.

In this implementation, due to the randomness of the group measurements, the step S104 may be performed N times to obtain N target group measurement results of the M first nodes.

In addition, since the measurement manner in the group measurement process is determined based on the angle information, and different angle information lead to different measurement manners and different final resultant grouping effects, this step may be performed N times to determine the grouping score under the measurement manner corresponding to this angle information, and the angle information may be updated based on this grouping score, and the group measurements may be performed repeatedly based on the updated angle information, to finally achieve the purpose of improving the grouping effect.

Specifically, the algorithm of the single-bit measurement scheme, that is, the target grouping operation, may be executed N times, and each outputted target group measurement result is recorded to obtain the N target group measurement results of the M first nodes, which are denoted by oᵢ respectively, wherein i=1, . . . , N. In the target grouping operations, group measurements may be performed using the single-bit measurement scheme of the above-mentioned implementation.

The grouping manners z corresponding to the N target group measurement results and the frequency of each grouping manner z are counted and denoted by p_{γ,β}(z):=|{i:oᵢ=z}|/N. A first target function value is calculated using a target function cₚ(γ, β)=Σ_{z∈{0,1}}_{^{M}}c(z)p_{γ,β}(z), where c(z)=Σ_{(u,v)∈E}(zᵤ ⊕ zᵥ).

Afterwards, cₚ(γ, β) is optimized by means of a classical optimizer based on the first target function value, and the values of γ and β, that is the angle information, are updated.

Based on the updated angle information, that is, the first angle information and the second angle information in the target grouping operation, the target grouping operation is performed N times again, that is, the above steps are performed cyclically, to obtain the second target function value until the difference between the first target function value and the second target function value obtained consecutively is less than a preset threshold, at which point the operation is stopped and the grouping manner corresponding to the target group measurement result occurred most frequently among the N target group measurement results is determined as the grouping output result of the M first nodes, and the grouping output result z′=arg max p_{γ,β}(z) is outputted. The preset threshold may be set according to the actual situation, which may be a pre-inputted parameter.

For example, if the bit string “0101” occurs most frequently among the N target group measurement results, and the grouping manner corresponding to this target group measurement result is that node 1 and node 3 are grouped into one group, and node 2 and node 4 are grouped into another group, then the grouping output result of the M first nodes may be the bit string “0101”, indicating the grouping manner: V₀={1,3} and V₁={2,4}.

Optionally, the step S103 specifically includes:

generating the quantum state of each of the K nodes;

performing a tensor product operation based on the quantum state of each of the K nodes to obtain a first operation result;

performing tensor product and matrix multiplication operations on Q pieces of control information to obtain a second operation result, wherein Q is determined based on the quantity of undirected edges included in the node circuit graph, and the control information is information corresponding to the control Z-gate; and

perform multiplication of the first operation result and the second operation result to obtain the quantum entangled state of the node circuit graph.

This implementation describes the process in which the node grouping apparatus constructs, based on a QAOA graph, a quantum entangled state of the QAOA graph, wherein the quantum entangled state of the QAOA may be referred to as a graph state of the QAOA graph.

Specifically, for the QAOA graph, a quantum state of each of the K nodes can be generated. The quantum state is the physical state of the node on the corresponding layer, that is, the subsystem. In a specific implementation, a quantum state |+ [symbol] =(|0 [symbol] +|1 [symbol] )/\sqrt{2} can be prepared. If two nodes are connected to each other by an undirected edge, a control Z-gate is applied to the quantum states corresponding to these two nodes, and the control information of the control Z-gate

$$CZ = \vert 0 〉 0 \vert ⊗ I + \vert 1 〉 〈 1 \vert ⊗ Z , \\ I = [ \begin{matrix}1 & 0 \\ 0 & 1\end{matrix} ] and Z = [ \begin{matrix}1 & 0 \\ 0 & - 1\end{matrix} ]$$

are Pauli matrices.

The application of a control Z-gate to the quantum states corresponding to these two nodes refers to performing the tensor product operation of the quantum states of the two nodes, followed by performing a matrix multiplication operation with the control information corresponding to the control Z-gate to obtain the output.

Since the control Z-gate is in a diagonal form and does not distinguish between control bits and controlled bits, multiple control Z-gates can be applied to the node circuit graph at one time, specifically, a tensor product operation may be performed based on the quantum state of each node of the K nodes to obtain a first operation result; and then a tensor product and matrix multiplication operation is performed on Q pieces of control information to obtain a second operation result, where Q is the quantity of undirected edges in the node circuit graph, subsequently, a multiplication of the first operation result and the second operation result is performed to obtain the quantum entangled state of the node circuit graph, which makes the computation shallower and thus allows further improvement of the algorithm evolution.

For example, for graph G, the following formula (7) can be used for generating the graph state of the graph G.

$$\vert G 〉 = {\prod }_{( u , v ) ∈ E} C {Z}_{u v} {\prod }_{v ∈ V} \vert + 〉 v \qquad ( 7 )$$

In the same way as the above formula (7), the graph state of the QAOA graph can be generated, denoted by |QAOA(G, p) [symbol] , i.e., the quantum entangled state of QAOA.

In this implementation, the quantum entangled state of the node circuit graph can be constructed based on the structure of the node circuit graph in the node grouping apparatus, so that the evolution of the QAOA algorithm can be implemented locally.

Optionally, the step S103 specifically includes obtaining a cluster state corresponding to the node circuit graph, and clipping the cluster state based on the node circuit graph, to obtain the quantum entangled state of the node circuit graph.

In this implementation, the node grouping apparatus may request a cluster state of a suitable size from another electronic device such as a cloud-based quantum server based on the constructed QAOA node circuit graph, to obtain a cluster state corresponding to the node circuit graph, where the cluster state refers to a generic quantum entangled state of the system. Afterwards, the cluster state is clipped according to the structure of the constructed QAOA node circuit graph, to obtain the quantum entangled state of the node circuit graph.

Since the requested cluster state is a generic quantum state that is independent of the QAOA algorithm, another electronic device such as a cloud-based quantum server cannot know what data is used and what algorithm is executed, thus allowing the QAOA algorithm to be applied to the quantum Internet for secure proxy computing, thereby protecting the privacy and computational security of the user during the evolution of the QAOA algorithm.

### The Second Embodiment

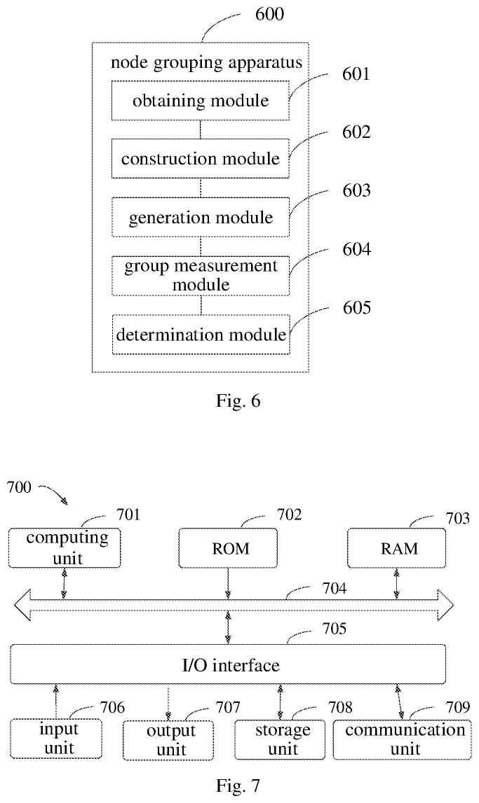

As shown in FIG. 6, the present disclosure provides a node grouping apparatus 600, which includes:

an obtaining module 601, configured to obtain a graph of nodes to be grouped, wherein the graph of nodes to be grouped includes M first nodes, and M is an integer greater than 1;

a construction module 602, configured to construct a QAOA (quantum approximate optimization algorithm) node circuit graph based on the graph of nodes to be grouped, wherein the node circuit graph includes K nodes, the K nodes include the M first nodes, and K is an integer greater than or equal to M;

a generation module 603, configured to generate a quantum entangled state of the node circuit graph, wherein the quantum entangled state includes the target quantum states of the K nodes in the node circuit graph;

a group measurement module 604, configured to perform a group measurement on each node of the K nodes sequentially based on the target quantum states of the K nodes in the node circuit graph, to obtain a target group measurement result of the M first nodes; and

a determination module 605, configured to determine the grouping output result of the M first nodes based on the target group measurement result of the M first nodes.

Optionally, the graph of nodes to be grouped includes undirected edges formed by the M first nodes, and the construction module 602 includes:

an adding unit, configured to add a second node to each undirected edge of the graph of nodes to be grouped, to obtain first node graphs;

a removing unit, configured to remove each undirected edge of the graph of nodes to be grouped, to obtain second node graphs; and

an alternate stacking unit, configured to alternately stack the first node graphs and the second node graphs in parallel and sequentially, to form the QAOA node circuit graph, wherein the quantity of the first node graphs is greater than the quantity of the second node graphs; and

wherein the K nodes further include added second nodes, and the node circuit graph further includes undirected edges formed by the K nodes.

Optionally, the group measurement module 604 includes:

a group measurement unit, configured to perform, sequentially according to the stacking order of the node graphs in the node circuit graph, the group measurement on each node in the node graphs based on the target quantum states of the K nodes in the node circuit graph, to obtain group measurement results of the k nodes; and

a first determination unit, configured to determine a target group measurement result of the M first nodes based on the group measurement results of the K nodes.

Optionally, the group measurement unit of the group measurement module 604 is specifically used for:

performing the group measurement on each second node of the first node graph based on the target quantum state of the second node in the node circuit graph by using a first target measurement manner, to obtain group measurement results of second nodes in the first node graph, wherein the first target measurement manner is a first measurement manner in which the measurement angle is determined based on group measurement results of first nodes in a first target node graph and first angle information, and the first target node graph is a second node graph stacked before the first node graph;

performing, in a case that a second node graph is stacked after the first node graph, the group measurement on each first node of the first node graph based on the target quantum state of the first node in the node circuit graph by using a second target measurement manner, to obtain group measurement results of M first nodes in the first node graph, wherein the second target measurement manner is a second measurement manner in which the measurement angle is 0;

performing the group measurement on each first node of the second node graph based on the target quantum state of the first node in the node circuit graph by using a third target measurement manner, to obtain group measurement results of M first nodes in the second node graph, wherein the third target measurement manner is a second measurement manner in which the measurement angle is determined based on the group measurement results of nodes in a second target node graph and second angle information, and the second target node graph is a first node graph stacked before the second node graph; and

performing, in a case that there is no second node graph stacked after the first node graph, the group measurement on each first node of the first node graph based on the target quantum state of the first node in the node circuit graph by using a fourth target measurement manner, to obtain group measurement results of M first nodes in the first node graph, wherein the fourth target measurement manner is a first measurement manner in which the measurement angle is determined based on the group measurement results of second nodes in the first node graph and second angle information.

Optionally, the first determination unit of the group measurement module 604 is specifically used for calculating, for each of the M first nodes, a summation of the group measurement result of the first node in the p-th first node graph and the group measurement result of the first node in the third target node graph, to obtain the target value corresponding to the first node, wherein the third target node graph is a second node graph stacked before the p-th first node graph, and p is equal to the quantity of the first node graphs; and also for performing a modulo operation on the target value to obtain target group measurement result of the first node.

Optionally, the group measurement module 604 includes:

a first execution unit, configured to perform the target grouping operation N times to obtain N target group measurement results of the M first nodes, wherein N is a positive integer, and the target grouping operation is: performing the group measurement on each of the K nodes sequentially based on the target quantum states of the K nodes in the node circuit graph;

a second determination unit, configured to determine a first target function value based on the N target group measurement results, wherein the first target function value is used for denoting the grouping score of the M first nodes in the performing the target grouping operation N times;

an update unit, configured to update angle information in the target grouping operation based on the first target function value, wherein the angle information is used for determining a measurement angle for performing the group measurement on each of the K nodes in the target grouping operation;

a second execution unit, configured to perform the target grouping operation N times again based on the updated angle information to determine a second target function value; and

a third determination unit, configured to determine, in a case that the difference between the first target function value and the second target function is less than a preset threshold, a grouping manner corresponding to a most frequently occurred target group measurement result among the N target group measurement results as a grouping output result of the M first nodes.

Optionally, the generation module 603 includes:

a generation unit, configured to generate the quantum state of each of the K nodes;

a first operation unit, configured to perform a tensor product operation based on the quantum state of each of the K nodes, to obtain a first operation result;

a second operation unit, configured to perform tensor product and matrix multiplication operations on Q pieces of control information to obtain a second operation result, wherein Q is determined based on the quantity of undirected edges included in the node circuit graph, and the control information is information corresponding to the control Z-gate; and

a third operation unit, configured to perform multiplication of the first operation result and the second operation result to obtain the quantum entangled state of the node circuit graph.

Optionally, the generation module 603 includes an obtaining unit, configured to obtain a cluster state corresponding to the node circuit graph, and a clipping unit, configured to clip the cluster state based on the node circuit graph to obtain the quantum entangled state of the node circuit graph.

The node grouping apparatus 600 provided in the present disclosure can realize the various processes implemented in the node grouping method embodiments and can achieve the same beneficial effects. In order to avoid repetition, details are not repeated here.

According to embodiments of the present disclosure, an electronic device, a readable storage medium and a computer program product are further provided.

FIG. 7 is a schematic block diagram of an exemplary electronic device 700 in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present disclosure described and/or claimed herein.

As shown in FIG. 7, the device 700 includes a computing unit 701. The computing unit 701 may carry out various suitable actions and processes according to a computer program stored in a read-only memory (ROM) 702 or a computer program loaded from a storage unit 708 into a random access memory (RAM) 703. The RAM 703 may as well store all kinds of programs and data required for the operation of the device 700. The computing unit 701, the ROM 702 and the RAM 703 are connected to each other through a bus 704. An input/output (I/O) interface 705 is also connected to the bus 704.

Multiple components in the device 700 are connected to the I/O interface 705. The multiple components include: an input unit 706, e.g., a keyboard, a mouse and the like; an output unit 707, e.g., a variety of displays, loudspeakers, and the like; a storage unit 708, e.g., a magnetic disk, an optic disc and the like; and a communication unit 709, e.g., a network card, a modem, a wireless transceiver, and the like. The communication unit 709 allows the device 700 to exchange information/data with other devices through a computer network such as the Internet, and/or other telecommunication networks.

The computing unit 701 may be any general purpose and/or special purpose processing components having a processing and computing capability. Some examples of the computing unit 701 include, but are not limited to: a central processing unit (CPU), a graphic processing unit (GPU), various special purpose artificial intelligence (AI) computing chips, various computing units executing a machine learning model algorithm, a digital signal processor (DSP), and any suitable processor, controller, microcontroller, etc. The computing unit 701 carries out the aforementioned methods and processes, e.g., the node grouping method. For example, in some embodiments, the node grouping method may be implemented as a computer software program tangibly embodied in a machine readable medium such as the storage unit 708. In some embodiments, all or a part of the computer program may be loaded and/or installed on the device 700 through the ROM 702 and/or the communication unit 709. When the computer program is loaded into the RAM 703 and executed by the computing unit 701, one or more steps of the foregoing node grouping method may be implemented. Optionally, in other embodiments, the computing unit 701 may be configured in any other suitable manner (e.g., by means of a firmware) to implement the node grouping method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), a computer hardware, a firmware, a software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN), the Internet and a blockchain network.

The computer system can include a client and a server. The client and server are generally remote from each other and typically interact through a communication network. The relationship of client and server arises by virtue of computer programs running on respective computers and having a client-server relationship to each other. The server can be a cloud server, also known as a cloud computing server or a cloud host. It is a hosting product in the cloud computing service system to solve the problem of difficult management and weak business scalability that exists in the traditional physical host and VPS service (“Virtual Private Server”, or “VPS” for short). The server can also be a server of a distributed system, or a server combined with a blockchain.

It is appreciated, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A node grouping method, comprising:
obtaining a graph of nodes to be grouped, wherein the graph of nodes to be grouped comprises M first nodes, and M is an integer greater than 1;
constructing a quantum approximate optimization algorithm (QAOA) node circuit graph based on the graph of nodes to be grouped, wherein the node circuit graph comprises K nodes, the K nodes comprise the M first nodes, and K is an integer greater than or equal to M;
generating a quantum entangled state of the node circuit graph, wherein the quantum entangled state comprises target quantum states of the K nodes in the node circuit graph;
performing a group measurement on each of the K nodes sequentially based on the target quantum states of the K nodes in the node circuit graph to obtain a target group measurement result of the M first nodes; and
determining a grouping output result of the M first nodes based on the target group measurement result of the M first nodes.

2. The node grouping method according to claim 1, wherein the graph of nodes to be grouped comprises undirected edges formed by the M first nodes, and the constructing the QAOA node circuit graph based on the graph of nodes to be grouped comprises:
adding a second node to each undirected edge of the graph of nodes to be grouped to obtain first node graphs;
removing each undirected edge of the graph of nodes to be grouped to obtain second node graphs;
alternately stacking the first node graphs and the second node graphs in parallel and sequentially to form the QAOA node circuit graph, wherein a quantity of the first node graphs is greater than a quantity of the second node graphs; and
wherein the K nodes further comprise the added second nodes, and the node circuit graph further comprises undirected edges formed by the K nodes.

3. The node grouping method according to claim 2, wherein performing the group measurement on each of the K nodes sequentially based on the target quantum states of the K nodes in the node circuit graph to obtain the target group measurement result of the M first nodes comprises:
performing, sequentially according to the stacking order of the node graphs in the node circuit graph, the group measurement on each node in the node graphs based on the target quantum states of the K nodes in the node circuit graph, to obtain group measurement results of the K nodes; and
determining the target group measurement result of the M first nodes based on the group measurement results of the K nodes.

4. The node grouping method according to claim 3, wherein performing the group measurement on each node in the node circuit graph sequentially according to the stacking order of the node graphs in the node circuit graph based on the target quantum states of the K nodes in the node circuit graph to obtain the group measurement results of the K nodes comprises:
performing the group measurement on each second node of the first node graph based on the target quantum state of the second node in the node circuit graph by using a first target measurement manner to obtain group measurement results of the second nodes in the first node graph, wherein the first target measurement manner is a first measurement manner in which a measurement angle is determined based on group measurement results of first nodes in a first target node graph and first angle information, and the first target node graph is the second node graph stacked before the first node graph;
performing, in a case that the second node graph is stacked after the first node graph, the group measurement on each first node of the first node graph based on the target quantum state of the first node in the node circuit graph by using a second target measurement manner to obtain group measurement results of M first nodes in the first node graph, wherein the second target measurement manner is a second measurement manner in which a measurement angle is 0;
performing the group measurement on each first node of the second node graph based on the target quantum state of the first node in the node circuit graph by using a third target measurement manner to obtain group measurement results of the M first nodes in the second node graph, wherein the third target measurement manner is the second measurement manner in which the measurement angle is determined based on the group measurement results of nodes in a second target node graph and second angle information, and the second target node graph is the first node graph stacked before the second node graph; and
performing, in a case that there is no second node graph stacked after the first node graph, the group measurement on each first node of the first node graph based on the target quantum state of the first node in the node circuit graph by using a fourth target measurement manner to obtain group measurement results of the M first nodes in the first node graph, wherein the fourth target measurement manner is the first measurement manner in which the measurement angle is determined based on the group measurement results of the second nodes in the first node graph and the second angle information.

5. The node grouping method according to claim 3, wherein determining the target group measurement result of the M first nodes based on the group measurement results of the K nodes comprises:
calculating, for each of the M first nodes, a summation of the group measurement result of the first node in a p-th first node graph and the group measurement result of the first node in a third target node graph, to obtain a target value corresponding to the first node, wherein the third target node graph is the second node graph stacked before the p-th first node graph, and p is equal to the quantity of the first node graphs; and performing a modulo operation on the target value to obtain the target group measurement result of the first node.

6. The node grouping method according to claim 2, wherein the performing the group measurement on each of the K nodes sequentially based on the target quantum states of the K nodes in the node circuit graph to obtain the target group measurement result of the M first nodes comprises:
performing a target grouping operation N times to obtain N target group measurement results of the M first nodes, wherein N is a positive integer, and the target grouping operation is: performing the group measurement on each of the K nodes sequentially based on the target quantum states of the K nodes in the node circuit graph;
determining a first target function value based on the N target group measurement results, wherein the first target function value is used for denoting a grouping score of the M first nodes in the performing the target grouping operation N times;
updating angle information in the target grouping operation based on the first target function value, wherein the angle information is used for determining a measurement angle for performing the group measurement on each of the K nodes in the target grouping operation;
performing the target grouping operation N additional times based on the updated angle information to determine a second target function value; and
determining, in a case that a difference between the first target function value and the second target function value is less than a preset threshold, a grouping manner corresponding to a most frequently occurred target group measurement result among the N target group measurement results as a grouping output result of the M first nodes.

7. The node grouping method according to claim 2, wherein generating the quantum entangled state of the node circuit graph comprises:
generating the quantum state of each of the K nodes;
performing a tensor product operation based on the quantum state of each of the K nodes to obtain a first operation result;
performing tensor product and matrix multiplication operations on Q pieces of control information to obtain a second operation result, wherein Q is determined based on the quantity of undirected edges included in the node circuit graph, and the control information is information corresponding to a control Z-gate; and
perform multiplication of the first operation result and the second operation result to obtain the quantum entangled state of the node circuit graph.

8. The node grouping method according to claim 2, wherein generating the quantum entangled state of the node circuit graph comprises:
obtaining a cluster state corresponding to the node circuit graph; and
clipping the cluster state based on the node circuit graph to obtain the quantum entangled state of the node circuit graph.

9. An electronic device, comprising:
at least one processor; and
a storage communicatively connected to the at least one processor,
wherein the storage stores therein an instruction configured to be executed by the at least one processor, and the at least one processor is configured to execute the instruction, to implement following steps:
obtaining a graph of nodes to be grouped, wherein the graph of nodes to be grouped comprises M first nodes, and M is an integer greater than 1;
constructing a quantum approximate optimization algorithm (QAOA) node circuit graph based on the graph of nodes to be grouped, wherein the node circuit graph comprises K nodes, the K nodes comprise the M first nodes, and K is an integer greater than or equal to M;
generating a quantum entangled state of the node circuit graph, wherein the quantum entangled state comprises target quantum states of the K nodes in the node circuit graph;
performing a group measurement on each of the K nodes sequentially based on the target quantum states of the K nodes in the node circuit graph to obtain a target group measurement result of the M first nodes; and
determining a grouping output result of the M first nodes based on the target group measurement result of the M first nodes.

10. The electronic device according to claim 9, wherein the graph of nodes to be grouped comprises undirected edges formed by the M first nodes, and the constructing the QAOA node circuit graph based on the graph of nodes to be grouped comprises:
adding a second node to each undirected edge of the graph of nodes to be grouped to obtain first node graphs;
removing each undirected edge of the graph of nodes to be grouped to obtain second node graphs;
alternately stacking the first node graphs and the second node graphs in parallel and sequentially, to form the QAOA node circuit graph, wherein a quantity of the first node graphs is greater than a quantity of the second node graphs; and
wherein the K nodes further comprise the added second nodes, and the node circuit graph further comprises undirected edges formed by the K nodes.

11. The electronic device according to claim 10, wherein performing the group measurement on each of the K nodes sequentially based on the target quantum states of the K nodes in the node circuit graph to obtain the target group measurement result of the M first nodes comprises:
performing, sequentially according to the stacking order of the node graphs in the node circuit graph, the group measurement on each node in the node graphs based on the target quantum states of the K nodes in the node circuit graph to obtain group measurement results of the K nodes; and
determining the target group measurement result of the M first nodes based on the group measurement results of the K nodes.

12. The electronic device according to claim 11, wherein performing the group measurement on each node in the node circuit graph sequentially according to the stacking order of the node graphs in the node circuit graph based on the target quantum states of the K nodes in the node circuit graph to obtain the group measurement results of the K nodes comprises:
performing the group measurement on each second node of the first node graph based on the target quantum state of the second node in the node circuit graph by using a first target measurement manner to obtain group measurement results of the second nodes in the first node graph, wherein the first target measurement manner is a first measurement manner in which a measurement angle is determined based on group measurement results of first nodes in a first target node graph and first angle information, and the first target node graph is the second node graph stacked before the first node graph;
performing, in a case that the second node graph is stacked after the first node graph, the group measurement on each first node of the first node graph based on the target quantum state of the first node in the node circuit graph by using a second target measurement manner to obtain group measurement results of M first nodes in the first node graph, wherein the second target measurement manner is a second measurement manner in which a measurement angle is 0;
performing the group measurement on each first node of the second node graph based on the target quantum state of the first node in the node circuit graph by using a third target measurement manner to obtain group measurement results of the M first nodes in the second node graph, wherein the third target measurement manner is the second measurement manner in which the measurement angle is determined based on the group measurement results of nodes in a second target node graph and second angle information, and the second target node graph is the first node graph stacked before the second node graph; and
performing, in a case that there is no second node graph stacked after the first node graph, the group measurement on each first node of the first node graph based on the target quantum state of the first node in the node circuit graph by using a fourth target measurement manner to obtain group measurement results of the M first nodes in the first node graph, wherein the fourth target measurement manner is the first measurement manner in which the measurement angle is determined based on the group measurement results of the second nodes in the first node graph and the second angle information.

13. The electronic device according to claim 11, wherein determining the target group measurement result of the M first nodes based on the group measurement results of the K nodes comprises:
calculating, for each of the M first nodes, a summation of the group measurement result of the first node in a p-th first node graph and the group measurement result of the first node in a third target node graph, to obtain a target value corresponding to the first node, wherein the third target node graph is the second node graph stacked before the p-th first node graph, and p is equal to the quantity of the first node graphs; and performing a modulo operation on the target value to obtain the target group measurement result of the first node.

14. The electronic device according to claim 10, wherein performing the group measurement on each of the K nodes sequentially based on the target quantum states of the K nodes in the node circuit graph to obtain the target group measurement result of the M first nodes comprises:
performing a target grouping operation N times to obtain N target group measurement results of the M first nodes, wherein N is a positive integer, and the target grouping operation is: performing the group measurement on each of the K nodes sequentially based on the target quantum states of the K nodes in the node circuit graph;
determining a first target function value based on the N target group measurement results, wherein the first target function value is used for denoting a grouping score of the M first nodes in the performing the target grouping operation N times;
updating angle information in the target grouping operation based on the first target function value, wherein the angle information is used for determining a measurement angle for performing the group measurement on each of the K nodes in the target grouping operation;
performing the target grouping operation N additional times based on the updated angle information to determine a second target function value; and
determining, in a case that a difference between the first target function value and the second target function value is less than a preset threshold, a grouping manner corresponding to a most frequently occurred target group measurement result among the N target group measurement results as a grouping output result of the M first nodes.

15. The electronic device according to claim 10, wherein generating the quantum entangled state of the node circuit graph comprises:
generating the quantum state of each of the K nodes;
performing a tensor product operation based on the quantum state of each of the K nodes to obtain a first operation result;
performing tensor product and matrix multiplication operations on Q pieces of control information to obtain a second operation result, wherein Q is determined based on the quantity of undirected edges included in the node circuit graph, and the control information is information corresponding to a control Z-gate; and
perform multiplication of the first operation result and the second operation result to obtain the quantum entangled state of the node circuit graph.

16. The electronic device according to claim 10, wherein generating the quantum entangled state of the node circuit graph comprises:
obtaining a cluster state corresponding to the node circuit graph; and
clipping the cluster state based on the node circuit graph, to obtain the quantum entangled state of the node circuit graph.

17. A non-transitory computer readable storage medium, storing therein a computer instruction, wherein the computer instruction is configured to be executed by a computer, to implement the method according to claim 1.

18. A computer program product, comprising a computer program, wherein the computer program is configured to be executed by a processor, to implement the method according to claim 1.
